(19) United States
(12) Patent Application Publication
(10) Pub. No.: US 2024/0309849 A1
(43) Pub. Date: Sep. 19, 2024

(54) Method for Wet-Towing and Installing a Wind Turbine Bucket Foundation

(71) Applicants: MooHyun Kim, College Station, TX (US); IkJae Lee, College Station, TX (US)

(72) Inventors: MooHyun Kim, College Station, TX (US); IkJae Lee, College Station, TX (US)

(73) Assignee: The Texas A&M University System, College Station, TX (US)

(21) Appl. No.: 18/604,623

(22) Filed: Mar. 14, 2024

Related U.S. Application Data
(60) Provisional application No. 63/490,260, filed on Mar. 15, 2023.

(51) Int. Cl. F03D 13/10; B63B 22/20

(52) U.S. Cl. CPC F03D 13/25; B63B 22/20; B63B 77/10; F03D 13/126; F05B 2240/95; F05B 2260/02

(57) ABSTRACT

Provided herein are methods and processes for wet-towing and installing a bucket foundation or mono-bucket for a wind turbine with or without the wind turbine mounted thereto in a body of water, such as a sea, an ocean or a lake. The methods and processes utilize at least a pair of wrap buoys secured to the bucket foundation or mono-bucket where the release thereof alters buoyancy such that the bucket foundation or mono-bucket submerges to a target site in the body of water.

### CROSS-REFERENCE TO RELATED APPLICATIONS

This non-provisional patent application claims benefit of priority under 35 U.S.C. § 119(e) of provisional application U.S. Ser. No. 63/490,260, filed Mar. 15, 2023, the entirety of which is hereby incorporated by reference.

### FEDERAL FUNDING LEGEND

This invention was made with government support under Contract Number 165319 sponsored by the U.S. Department of Energy-New York State Energy Research and Development Authority. The government has certain rights in the invention.

### BACKGROUND OF THE INVENTION

### Field of the Invention

The present invention relates generally to the fields of wind turbines and offshore installation thereof. More specifically, the present invention relates to wet-towing and installation of suction bucket foundations for offshore wind turbines without using heavy lift vessels.

### Description of the Related Art

The importance of offshore wind turbine for supplying green energy has been widely recognized among many countries during the past decade. Among the installed offshore wind turbines, the fixed monopile type foundation has mostly been used in relatively shallow water regions. Their sizes are also growing since larger turbines have higher efficiency and more advantages and require higher capacity heavy lift vessels (HLVs). The standard NREL fixed foundation for 15 MW turbine consists of a 10 m diameter, 75 m long, 1318 ton monopile (1, 2) that is driven 45 m into the seabed. Mono-pile foundation has to be driven into soil by impact hammers which generate unwanted noises to potentially disturb sea mammals. The presence of rock layers can also be a concern for deep pile penetration. In this regard, other types of fixed foundations, such as gravity foundation (3, 4) and suction-bucket foundation (5-8) are also considered due to no need of hammering, wider adaptability to various soil conditions, and relatively low construction/installation cost (9, 10).

The standard methodology for the installation of fixed-type foundations is to use installation vessels with a high-capacity crane. However, its safety, low availability, high day rate are challenging issues for large-scaled (e.g., 15 MW) offshore wind turbines (11). Alternatively, a dedicated transportation and installation vessel was devised for the bucket foundation by Zhang et al. (10).

Thus, there is a need in the art for a method for the wet-towing and installation of a bucket foundation or similar fixed-type foundation without using heavy lift vessels. The present invention fulfills this long-standing need in the art.

### SUMMARY OF THE INVENTION

The present invention is directed to method for installing a wind turbine bucket foundation at a target location on a seabed. In this method, a set of buoyancy devices is attached to an outer wall of the bucket foundation. The bucket foundation is towed to the target location and it is positioned over the target location. A pair of buoyancy devices are released symmetrically one-by-one from the outer wall. The releasing step is repeated until all the buoyancy devices are free such that the bucket foundation is positioned on the target location on the seabed. The present invention is directed to a related method further comprising retrieving the set of buoyancy devices for reuse.

The present invention is further directed to a wet-towing process for installing a wind turbine in a body of water. In this method, a segmented wrap buoy comprising an even number of buoy units is secured to a bucket foundation attached to the wind turbine. The bucket foundation is wet-towed to an installation site on the body of water. Pairs of buoy units comprising the segmented wrap buoy are released one-by-one via an acoustic signal to sequentially lower the bucket foundation onto the installation site in the body of water. The segmented wrap buoy is retrieved for reuse.

The present invention is directed further to a method for wet-towing a wind turbine for installation in a body of water. In this method, the wind turbine is mounted to a mono-bucket forming a single unit and a pair of wrap buoys is disposed around the mono-bucket. The mono-bucket is towed to an installation site on a body of water where a first wrap buoy of the pair is released. A second wrap buoy of the pair is ballasted to submerge the mono-bucket to a target water depth in the body of water.

The present invention is directed further to a method for installing a wind turbine in a body of water. In this method, at least a bucket foundation component for a wind turbine is towed to a target site on the body of water, where the bucket foundation is encircled with at least two wrap buoys. The bucket foundation is submerged via release of at least one wrap buoy to land on the target site in the body of water.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1D is a schematic summary of the process for transportation and installation illustrating the steps of fabricating and moving the bucket into water (FIG. 1A), wet-towing the bucket to the installation with target draft (FIG. 1B), sequentially releasing each pair of wrap buoys (FIG. 1C), and releasing the two remaining wrap buoys and retrieving the buoys (FIG. 1D).

FIGS. 2A-2I are cross-sectional views (FIGS. 2A, 2C-2D and 2H) and top views (FIGS. 2B, 2E-2G and 2I) illustrating the steps in FIG. 1C.

FIG. 3 illustrates intact stability in a wet tow.

FIG. 4 is a JONSWAP (Joint North Sea Wave Project) wave spectrum with different tow speeds.

FIG. 5 illustrates the lowering operation.

FIG. 6 illustrates a seabed landed bucket foundation subjected to the overturning moment.

FIGS. 7A-7D are side views illustrating wet-towing and installation on the seabed of a wind turbine mounted onto a mono-bucket.

FIGS. 8A-8B show the dimensions of slender (FIG. 8A) and wide (FIG. 8B) mono-buckets and the corresponding wrap buoys.

FIGS. 9A-9D KBs for partially submerged wrap buoys (stages 2-4) (FIGS. 9A-9B) and non-axisymmetric second moment of waterplane area (stages 3-4) (FIGS. 9C-9D).

FIG. 10 shows a hydrodynamics mesh in wet-towing (L/D=1.0).

FIGS. 11A-11B show response amplitude operators (RAOs) (L/D=1.0) for heave (FIG. 11A) and pitch (FIG. 11B).

FIGS. 12A-12B are motion spectra (L/D=1.0) for heave (FIG. 12A) and pitch (FIG. 12B).

FIG. 13 shows a hydrodynamics mesh in the lowering phase (L/D=1.0).

FIGS. 14A-14B are time series of transient motions between stage 4 and 5 for draft change (FIG. 14A) and heave velocity (FIG. 14B) (L/D=1.0).

FIG. 15 shows a hydrodynamics mesh in wet-towing (L/D=0.5).

FIGS. 16A-16B show response amplitude operators (RAOs) (L/D=0.5) for heave (FIG. 16A) and pitch (FIG. 16B).

FIGS. 17A-17B are motion spectra (L/D=0.5) for heave (FIG. 17A) and pitch (FIG. 17B).

FIG. 18 shows a hydrodynamic mesh in the lowering phase (L/D=0.5)

FIGS. 19A-19B are time series of transient motions between stage 5 and 6 for draft change (FIG. 19A) and heave velocity (FIG. 19B) (L/D=0.5).

### DETAILED DESCRIPTION OF THE INVENTION

As used herein, the articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention.

As used herein, the term “or” in the claims refers to “and/or” unless explicitly indicated to refer to alternatives only or the alternatives are mutually exclusive, although the disclosure supports a definition that refers to only alternatives and “and/or”.

As used herein, the terms “comprise” and “comprising” are used in the inclusive, open sense, meaning that additional elements may be included.

As used herein, the terms “consists of” and “consisting of” are used in the exclusive, closed sense, meaning that additional elements may not be included.

As used herein, the term “includes” or “including” is used herein to mean “including, but not limited to”. The terms “includes”, “including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., ±5-10% of the recited value) that one of ordinary skill in the art would consider equivalent to the recited value (e.g., having the same function or result). In some instances, the term “about” may include numerical values that are rounded to the nearest significant figure.

As used herein, the terms “bucket foundation”, “suction bucket” and “mono-bucket” are used interchangeably.

In one embodiment of the present invention, there is provided a method for installing a wind turbine bucket foundation at a target location on a seabed, comprising attaching a set of buoyancy devices to an outer wall of the bucket foundation; towing the bucket foundation to the target location and positioning it over the target location; releasing one-by-one a pair of buoyancy devices symmetrically from the outer wall; repeating the releasing step until all the buoyancy devices are free such that the bucket foundation is positioned on the target location on the seabed. Further to this embodiment, the method comprises retrieving the set of buoyancy devices for reuse.

In both embodiments, the attaching step may comprise securing the buoyancy devices to the outer wall of the bucket foundation via upper cables, lower cables, upper acoustic shackles and lower acoustic shackles. In both embodiments, the releasing step may comprise unsecuring the lower acoustic shackles via remote control to elevate a buoyancy center of the bucket foundation; unsecuring symmetrically a pair of the buoyancy devices via a remote acoustic signal to alter a weight-buoyancy equilibrium to lower the bucket foundation; and repeating the step of symmetrically unsecuring a pair of the buoyancy devices one-by-one until the bucket foundation rests on the seabed at the target location. In addition, the set of buoyancy devices may comprise a segmented wrap-buoy.

In another embodiment of the present invention, there is provided a method for a wet-towing process for installing a wind turbine in a body of water, comprising securing a segmented wrap buoy comprising an even number of buoy units to a bucket foundation attached to the wind turbine; wet-towing the bucket foundation to an installation site on the body of water; releasing pairs of buoy units comprising the segmented wrap buoy one-by-one via an acoustic signal to sequentially lower the bucket foundation onto the installation site in the body of water; and retrieving the segmented wrap buoy for reuse.

In an aspect of this embodiment, the securing step may comprise attaching the segmented buoy to the bucket foundation via acoustic shackles and cables. In another aspect of this embodiment, the releasing step may comprise sending a signal to remotely release the acoustic shackles; and sending an acoustic signal to sequentially release the pairs of buoy units. In this embodiment, releasing each pair of buoy units may alter a weight-buoyancy equilibrium, thereby lowering the bucket foundation into the body of water until the installation site is reached. In this embodiment and all aspects thereof, the body of water may be an ocean, a sea or a lake, said bucket foundation sequentially lowered to an ocean bed, a seabed or a lake bed.

In yet another embodiment of the present invention, there is provided a method for wet-towing a wind turbine for installation in a body of water, comprising mounting the wind turbine to a mono-bucket forming a single unit; disposing a pair of wrap buoys around the mono-bucket; towing the mono-bucket to an installation site on a body of water; releasing a first wrap buoy of the pair; and ballasting a second wrap buoy of the pair to submerge the mono-bucket to a target water depth in the body of water.

In this embodiment, the first wrap buoy may be an upper buoy and the second wrap buoy is a lower buoy. In an aspect of this embodiment, the upper wrap buoy after release may be free-floating and provides stability without buoyancy to the unit during the ballasting step. In this embodiment and aspect thereof, the body of water may be an ocean, a sea or a lake, said target water depth down to an ocean bed, a seabed or a lake bed.

In yet another embodiment of the present invention, there is provided a method for installing a wind turbine in a body of water, comprising: towing at least a bucket foundation component for a wind turbine to a target site on the body of water, where the bucket foundation is encircled with at least two wrap buoys; and submerging the bucket foundation via release of at least one wrap buoy to land on the target site in the body of water. In this embodiment, the target site may be on an ocean bed, a seabed or a lakebed.

In one aspect of this embodiment, the bucket foundation may be encircled with a segmented wrap buoy with an even number of segments, where each segment of the wrap buoy is secured to the bucket foundation via an upper acoustic shackle and a lower acoustic shackle, where the submerging step may comprise unsecuring the lower acoustic shackles on each segment of the wrap buoy via remote control to elevate a buoyancy center of the bucket foundation; unsecuring symmetrically a pair of the segments via a remote acoustic signal to alter a weight-buoyancy equilibrium to lower the bucket foundation; and repeating the step of symmetrically unsecuring a pair of the segments one-by-one until the bucket foundation rests on the target site. Further to this embodiment and aspect thereof, the method may comprise retrieving the segmented wrap buoy for reuse.

In another aspect of this embodiment, the bucket foundation may comprise the wind turbine secured thereto to form a single unit for towing. In this aspect the bucket foundation comprises an upper wrap buoy and a lower wrap buoy each circumferentially attached thereto, where the submerging step may comprise releasing the upper wrap buoy thereby providing stability without buoyancy to the single unit; and ballasting the lower wrap buoy to submerge the bucket foundation to rest on the target site.

Provided herein are methods and processes for the wet-towing, for example, vertical wet-towing, and stepwise installation of mono-bucket or suction bucket foundations for offshore wind turbines. The wind turbines may have, but are not limited to, a generating capacity up to 15 MW, including a 5 MW and a 10 MW capacity. Generally, a plurality of buoyancy devices or buoy units, such as, wrap buoys, for example, but not limited to, a segmented wrap buoy are releasably secured to the bucket foundation by acoustic shackles where an acoustic signal is utilized to sequentially release a pair of wrap buoy segments one-by-one from the bucket foundation. Buoyancy is thereby decreased in a stepwise manner and the bucket foundation lands on a target site, such as, on a seabed, an ocean bed or a lake bed. Alternatively, when the wind turbine is mounted on the bucket foundation thereby forming one or a single unit prior to towing, a pair of wrap buoys, such as, an upper wrap buoy and a lower ballasted wrap buoy are secured to the bucket. The acoustic release of the upper buoy enables it to float and slide on the surface of the body of water and to provide stability to the unit, but not buoyancy. The ballasted lower wrap buoy enables the unit to sink slowly to the target site. It is contemplated that these methods and processes may be applied to a jacket foundation with multiple smaller suction buckets.

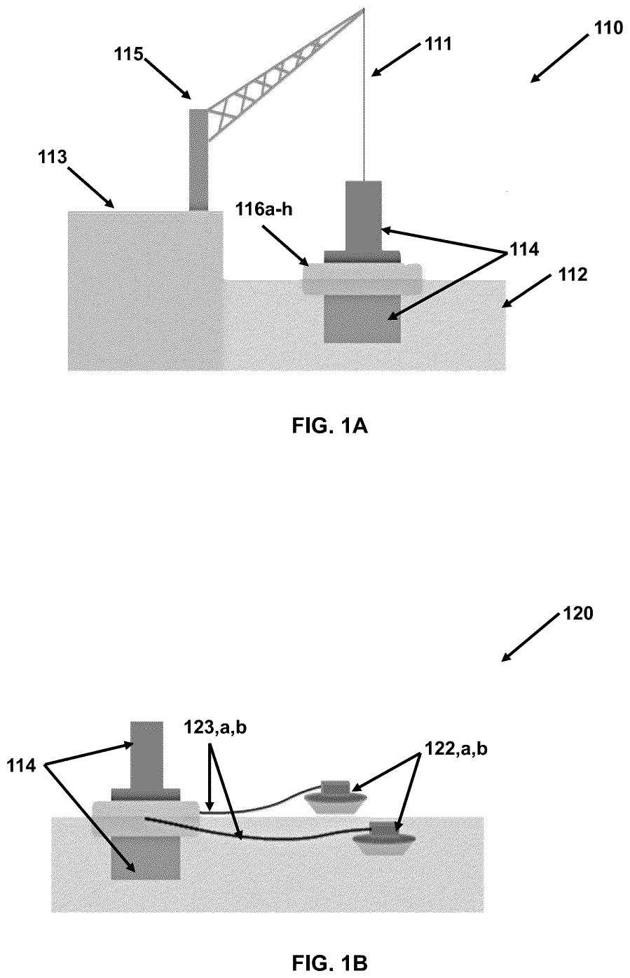

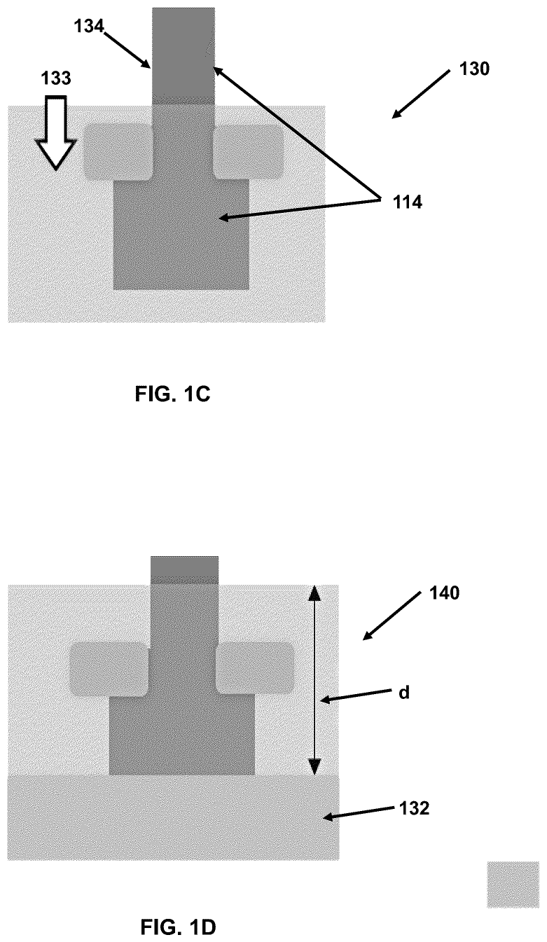

Particularly, embodiments of the methods of the present invention are better illustrated with reference to at least FIGS. 1A-1D, 2A-2I, 3-6, and 7A-7D, however, such reference is not meant to limit the present invention in any fashion. The embodiments and variations described in detail herein are to be interpreted by the appended claims and equivalents thereof.

FIGS. 1A-1D represent the overall process for wet-towing and stepwise installation. In this process, the bucket foundation was sized for a NREL 15 MW wind turbine at a water depth or draft of 30 m. It is assumed that the seabed at the installation location was pretreated to be flat.

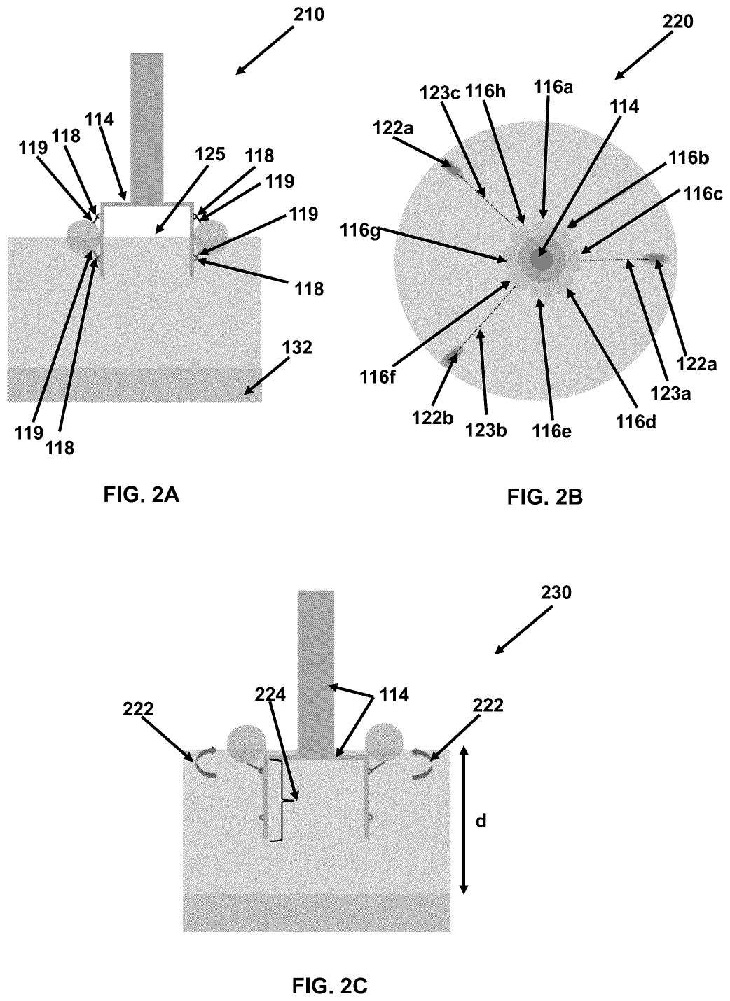

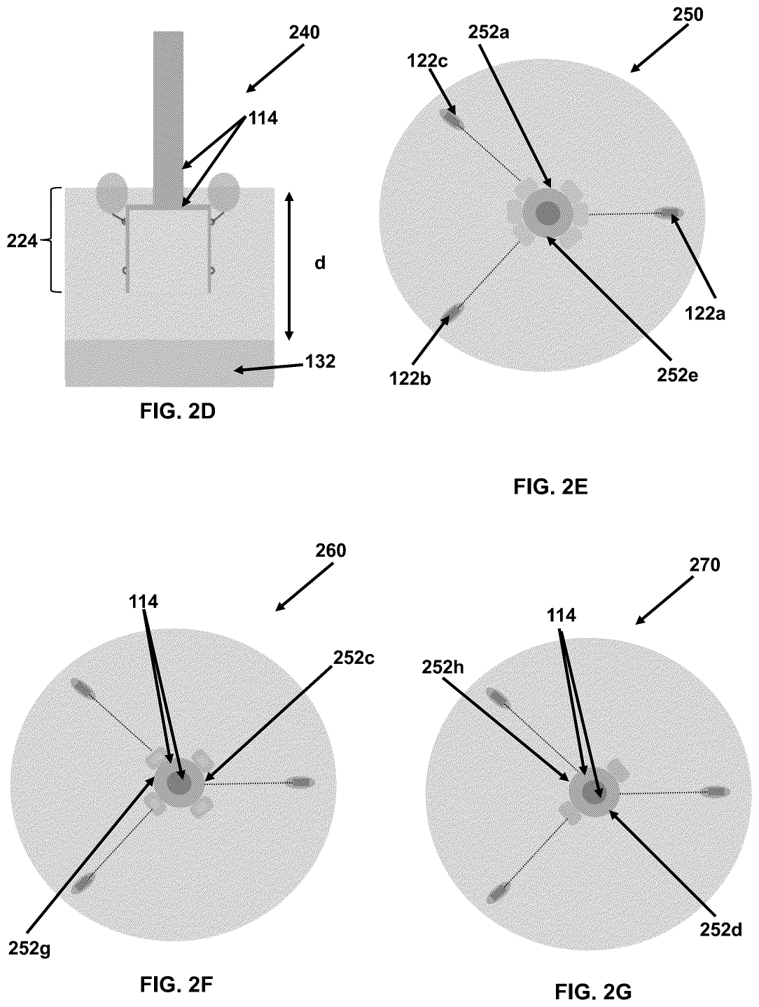

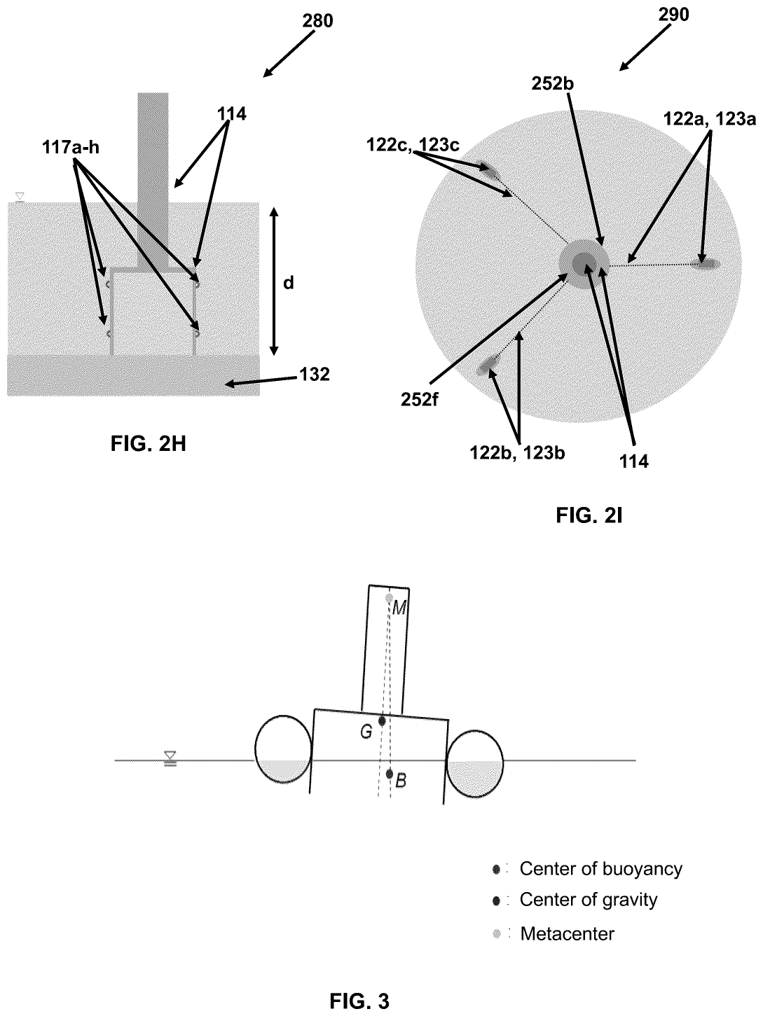

FIG. 1A is a schematic of step 1 110 generally showing the fabricated bucket being moved at 111 into the water 112. All components of the bucket foundation 114 including the assisting segmented wrap-buoy units overall represented by 116a-h (see FIG. 2B for view of the plurality of units) are assembled at quayside land 113. Then, the bucket foundation is placed into the water by using a land crane 115. During the loadout, the segmented wrap buoys enable the foundation to be afloat. The segmented wrap buoys are connected to the upper and lower bucket pad-eyes 117a-h (see FIG. 2H) at both ends through upper and lower acoustic shackles represented by 118 and upper and lower short cables represented by 119 (see FIG. 2A). The acoustic shackles are disconnected remotely by using acoustic signal during the installation.

With continued reference to FIG. 1A, FIG. 1B is a schematic of step 2 120 generally showing wet-towing the bucket foundation 114 and attached segmented wrap buoy to the installation site with target draft. The floating unit, i.e., the bucket foundation and segmented wrap buoy, is towed by three tugboats 122a,b,c (122c not shown, see FIG. 2B) via towing lines 123a,b,c (123c not shown, see FIG. 2B) to the installation site 125 (see FIG. 1D).

With continued reference to FIG. 1A, FIG. 1C is a schematic of step 3 130 generally illustrating submergence of the bucket foundation 114. At the installation site, the three tugboats position the bucket foundation to be located directly above the target seabed 132 (see FIG. 1D). Once the bucket foundation is positioned, the lower acoustic shackles of all wrap buoys (see FIG. 2C) are released by remote control to elevate the buoyancy center while initially lowering the bucket foundation at 133 to the target draft or depth d (see FIG. 1D). Then, each pair of segmented wrap buoys is remotely released one-by-one in a symmetric manner by acoustic signal. After each pair of wrap buoys is released, the corresponding loss of buoyancy is compensated by the increased buoyancy of the upper tower 134 of the bucket foundation 114 by deeper submergence. Then, the bucket foundation reaches a new weight-buoyancy equilibrium draft. The remote releasing processes are repeated until the lowest part of the bucket foundation lands at the seabed. During the sequential lowering process, the static stability is maintained. The additional stability also is provided by the tensions of the three tug-boat cables.

With continued reference to FIG. 1C, FIG. 1D is a schematic of step 4 140 illustrating release of the two remaining wrap buoys and complete submergence of the bucket foundation 114 onto the target seabed 132. After the bucket foundation has completely landed on the seabed at the target draft or depth d, all the disconnected wrap buoys are afloat and are retrieved by the tugboats for reuse. Tugboats bring those retrieved wrap-buoys to the port for the next operation.

With continued reference to FIG. 1C, FIGS. 2A-2I illustrate the installation process of step 3 130 in which the bucket foundation is lowered in a stepwise manner via the remote symmetrical release of the acoustic shackles until a safe landing at the target seabed within tolerance. The bucket foundation maintains its draft at pre-calculated equilibrium positions (stages 1-5), at each of which the weight of the foundation is in equilibrium with the buoyancy force. The cables from the three tugs provide additional stability and safety during submergence. At every equilibrium draft, the corresponding upright stability need is checked. Hydrostatic and hydrodynamic analyses are performed.

FIG. 2A is a cross-sectional view 210 of the bucket foundation 114 with 2 of the wrap buoys shown attached thereto via upper and lower acoustic shackles 118 and short cables 119 and positioned at the installation site 125 over the target seabed 132 with a target draft of 30 m.

FIG. 2B is a top view 220 of FIG. 2A showing the bucket foundation 114 with wrap buoys 116a-h positioned over the target seabed at the installation site by the three tugboats 122a,b,c via the cables 123a,b,c.

FIG. 2C is a cross-sectional view 230 illustrating the release at 222 of the lower acoustic shackles from the lower bucket pad-eyes so that the released wrap buoys are elevated at 222 and the draft 224 of the suction bucket 114 is increased.

With continued reference to FIG. 20, FIG. 2D is a cross-sectional view 240 illustrating that the bucket foundation 114 starts to submerge down to the target depth d on the seabed 132 and increases the bucket draft 224 after release of a pair of the wrap buoys 116a-h (see FIGS. 2E-2F).

FIG. 2E is a top view 250 of FIG. 2E illustrating the release of wrap buoys 116a,e at 252a,e as the three tugboats 122a,b,c maintain the position of the bucket foundation 114.

With continued reference to FIG. 2E, FIGS. 2F, 2G are top views 260 and 270 illustrating the respective release of the wrap buoy pair 116c,g at 252c,g and wrap buoy pair 116d,h at 252d,h as the tugboats maintain the position of the bucket foundation 114. After release of wrap buoys 116d,h the buoys are fully submerged and the buoyancy is increased by the increased submergence of the bucket foundation.

FIG. 2H is a cross-sectional view 280 showing the upper and lower bucket pad-eyes represented by 117a-h on the bucket foundation illustrating the release of the last pair of wrap buoys 116b,f (see FIG. 2I) and the landing of the bucket foundation at the target depth d on the target seabed 132.

With continued reference to FIG. 2H, FIG. 2I is a top view 290 showing that the last wrap buoys 116b,f are removed at 252b,f and that during the final stage of the lowering operation in FIG. 2H, the position of the bucket foundation 114 is adjusted by the three tugs 122a,b,c via the cables 123a,b,c.

FIG. 3 illustrates intact stability. In the transportation and installation phases, the floating bucket foundation needs to resist overturning moment for rolling and pitching due to waves, currents, and winds. The metacentric height (GM) is a good indication of the stability of a floating body. The GM is the distance from the center of gravity to the metacenter of a floating body and positive GM means that the system is stable against the overturning moment. The GM can be calculated by:

$$\overline{GM} = {𝓏}_{B} - {𝓏}_{G} + \frac{{I}_{xx}}{∇} , \qquad Eq . 1$$

where ∇ is the displaced volume, Iₓₓ is the second moment of waterplane area, z_{B} and z_{G} are center of buoyancy and gravity, respectively.

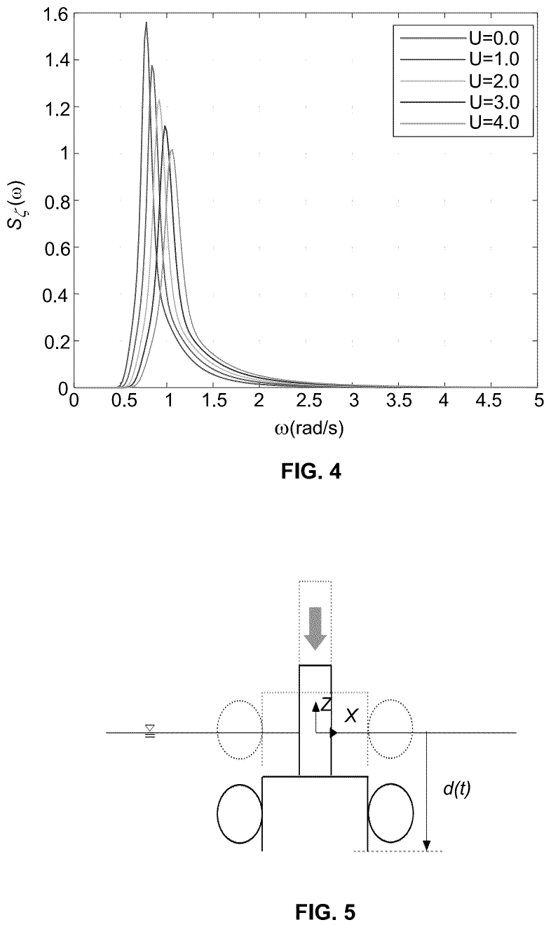

FIG. 4 shows a JONSWAP wave amplitude spectra (12) generated from Met-ocean parameters for sea state 4 shown in Table 1 where:

$${S}_{ζ} ( ω ) = ( 1 - 0.287 ln γ ) ( 5 / 16 ) {H}_{S}^{2} {ω}_{p}^{4} {ω}^{- 5} {e}^{- b {ω}_{p}^{4} / {ω}^{4}} {γ}^{a} with a = {e}^{{e ( ω - {ω}_{p} )}^{2} / 2 {ω}_{p}^{2} {σ}^{2}} \qquad Eq . 2$$

where ωₚ is peak frequency and Hₛ is significant wave height, γ is the peak enhancement factor, b=1.25, σ is spectral width parameter, σ=0.07 if ω≤ωₚ, otherwise σ=0.09.

The wave spectra for different tow speeds are generated based on the encounter-frequency conversion:

$${S}_{ζ} ( {ω}_{e} ) = {S}_{ζ} ( ω ) ( \frac{{C}_{g}}{{C}_{g} - U cos β} ) with {ω}_{e} = ω - kU cos β \qquad Eq . 3$$

where the group velocity

$$( {C}_{g} = \frac{1}{2} {C}_{p} ( 1 + \frac{2 kh}{sinh 2 kh} ) ;$$

the phase velocity

$${C}_{p} = \sqrt{\frac{g}{k} tarh kh} .$$

ωₑ is the encounter frequency determined by tow speed, U, and wave heading angle, β.

TABLE 1
Met-ocean parameters for sea-state 4

| T_{P}(s) | H_{S}(m) | γ | β(°) | U(m/s) |
|---|---|---|---|---|
| 8.1 | 2.5 | 3.3 | 180 | 0, 1, 2, 3, 4 |

The peak enhancement factor γ is chosen as 3.3 that has been used for many engineering works but it varies according to target locations (13).

The equation of motion in the frequency-domain is given by

$$[ ( - {ω}_{e}^{2} ( {M}_{ij} + {A}_{ij} ) + {C}_{ij} ) + i {ω}_{e} ( {B}_{ij}^{V} + {B}_{ij}^{R} ) ] {ξ}_{j} = {X}_{i} , \qquad Eq . 4$$

where Mᵢⱼ and Aᵢⱼ are inertia (mass) and added inertia, Bᵢⱼ^{V} and Bᵢⱼ^{R} are viscous (linear equivalent) and radiation damping, Cᵢⱼ is hydrostatic stiffness, Xᵢ is wave exciting force and moment. Subscripts i=1-6 and j=1-6 mean respective modes of 6 DOF motions. To calculate frequency dependent added mass, radiation damping and wave excitations in (4), a commercial 3D diffraction/radiation panel program WAMIT is used (14). For simplicity, the tow-line-induced additional effects are neglected. Since tugboats are small, their hydrodynamic interaction effects are not considered either. The linear equivalent viscous damping is additionally inputted to the program with 3% and 5% of critical damping for heave and pitch, respectively.

Based on Equation 4, heave and pitch motion RAOs are calculated as

$$\vert {RAO}_{ξ} \vert = \vert {ξ}_{i} \vert = \frac{\vert {X}_{i} \vert}{\sqrt{{( - {ω}_{e}^{2} ( {M}_{ii} + {A}_{ii} ) + {C}_{ii} )}^{2} + {{ω}_{e}^{2} ( {B}_{ii}^{V} + {B}_{ii}^{R} )}^{2}}} , i = 3 , 5. \qquad Eq . 5$$

Motion spectrum and their statistics are estimated based on the input wave spectrum and RAOs. In the linear time-invariant system, motion spectrum may be obtained as S_{ξ}_{ᵢ} (ωₑ)=S_{ζ}(ωₑ)|RAO_{ζ}_{ᵢ}|² . Based on them, several wave and motion statistics are estimated as follows: σ=\sqrt{m₀}: Standard deviation, ηₛ=2\sqrt{m₀}: Significant wave(motion) amplitude, and η_{E}=σ_{η}\sqrt{2 ln(10800/T₂)}: The most probable extreme wave(motion) amplitude for 3 hours where η is either ζ (wave) or ξᵢ (motion amplitude for i-mode), mᵢ=∫₀^{∞}(ωₑ)ⁱS(ωₑ)dωₑ, and mean wave period T₂=2π\sqrt{m₀/m₂}.

With continued reference to FIGS. 2A-21, FIG. 5 is a schematic for the lowering operation. Dynamic simulations in the respective lowering steps have been carried out. Each disconnection step causes transient up-and-down motions of the floating system until equilibrium draft is set. As shown in FIGS. 2A-2I, the mono-bucket foundation is lowered down in a stepwise manner, i.e., two segmented wrap buoys are released at a time in a symmetrical manner by the acoustic signal which commands the acoustic shackles to be released. Owing to the sudden decrease of buoyancy force by the disconnected wrap buoys, the foundation starts to fall until the buoyancy deficiency is compensated by the increased submergence of upper tower. During this short period, transient heave motions of the system occur. At the end of each transient response, the bucket reaches a new equilibrium position at which the buoyancy is balanced by the weight. This process is repeated until the bucket foundation is safely landed on the seabed. The transient heave responses and velocities are estimated from the separate time-dependent transient motion analysis for the respective stages. The worst scenario at which GM becomes minimum is selected among all the lowering steps for more detailed analysis. In the figure, d(t) is the instantaneous draft from the mean water level (z=0) to the bucket's bottom.

The equation of transient motion is given by

$$\\ \begin{matrix}( M + {A}_{33} ( ∞ ) ) \ddot{𝓏} ( t ) + {C}_{D}^{{}_{} *} \dot{𝓏} \vert \dot{𝓏} \vert + {\int }_{- ∞}^{t} {K}_{33} ( t - τ ) \dot{𝓏} ( τ ) d τ + {C}_{33} 𝓏 ( t ) = B - W + T & Eq . 6\end{matrix}$$

where, A₃₃(∞) is the infinite frequency added mass in heave direction, C_{D}*=0.5ρ(C_{D,n}A_{F,z}+C_{d,t}A_{Wet}), ρ is the water density, C_{D,n} and C_{d,t} are drag coefficients for normal and tangential direction, and A_{F,z} and A_{Wet} are the frontal area of bucket and wrap buoys projected to xy-plane and wetted area of bucket, respectively, C₃₃=ρgA_{WP}; A_{WP} is the waterplane area, K₃₃ is the retardation function standing for memory effect of radiation damping. It can be obtained from the cosine Fourier transform of radiation damping, and B and W are buoyancy and gravity forces, and T is the vertical component of tension from towing lines.

The three-dimensional hydrodynamic coefficients need to be calculated from the 3D diffraction/radiation program. Considerable radiated waves are expected during the initial stage of lowering operation due to the presence of wrap buoys particularly when it is at or near the free surface. In fact, the variation of radiation damping with the change of draft needs to be incorporated. The influence of trapped water inside the bucket is found to be significant, which results in high added mass that amounts to about 4-6 times of the foundation's mass according to the present numerical tests. On the other hand, drag coefficient, C_{D,n}=2.5, of the bucket is selected based on experimental data by Huang et al. (15) and Det Norske Veritas guideline (16). Moreover, the skin friction coefficient, C_{D,t} is set as 0.008 based on the recommended value for a suction anchor in OrcaFlex (17). The tensile forces, T, from towing lines of three tugboats are assumed to be 100-200 kN that is reasonable considering the general capacity of bollard pulls of tugs. The corresponding variation of tension by transient motions are assumed to be much smaller than the applied static tension. The main concern in the stepwise lowering operation is the maximum overshoot motion amplitude and velocity that occur immediately after the wrap-buoy is disconnected especially at the last lowering stage of the foundation, for which the bucket bottom is close to the seabed. The cable tensile forces can be a help in the last lowering stage close to seabed. The cable tensions are expected to be adjustable by changing tug-boat positions or cable winch. For the numerical simulation, Runge-Kutta Gill method is adopted for the time-domain solutions (18).

Let y=ż, then the Eq. 6 can be rewritten as a state-space equation

$$\\ \begin{matrix}\dot{y} = \{ \begin{matrix}\dot{𝓏} \\ \dot{y}\end{matrix} \} = \{ \begin{matrix}y \\ \frac{1}{M + {A}_{33} ( ∞ )} ( - W + B - {C}_{33} 𝓏 - {C}_{D}^{{}_{} *} y \vert y \vert - {\int }_{- ∞}^{t} {K}_{33} ( t - τ ) y ( τ ) d τ )\end{matrix} \} & Eq . 7\end{matrix}$$

$$\\ with y ( 0 ) = \{ \begin{matrix}0 \\ 0\end{matrix} \}$$

where the heave retardation function

$$\\ {K}_{33} ( t ) = \frac{2}{π} {\int }_{0}^{∞} {B}_{33} ( ω ) cos ( ω t ) d ω ;$$

B₃₃(ω) is frequency-dependent heave radiation damping. It should be noted that the hydrodynamic coefficients are for zero towing speed.

The discretized equation may be written as

$$\\ \begin{matrix}{y}_{n + 1} = {y}_{n} + \frac{1}{6} [ {k}_{1} + ( 2 - \sqrt{2} ) {k}_{2} + ( 2 + \sqrt{2} ) {k}_{3} + {k}_{4} ] + O ( {h}^{{}_{} 5} ) & Eq . 8\end{matrix}$$

where

$$\\ \{ \begin{matrix}{k}_{1} = Δ tf ( {t}_{n} , {y}_{n} ) \\ {k}_{2} = Δ tf ( {t}_{n} + Δ t / 2 , {y}_{n} + {k}_{1} / 2 ) \\ {k}_{3} = Δ tf ( {t}_{n} + Δ t / 2 , {y}_{n} + ( - 1 + \sqrt{2} ) {k}_{1} / 2 + ( 1 - \sqrt{2} / 2 ) {k}_{2} / 2 ) \\ {k}_{4} = Δ tf ( {t}_{n} + Δ t , {y}_{n} - ( \sqrt{2} / 2 ) {k}_{2} + ( 1 + \sqrt{2} / 2 ) {k}_{3} )\end{matrix} ;$$

Δt is the time step increment with

$$\\ f ( t , {y}_{n} ) = \{ \begin{matrix}{y}_{n} \\ \frac{1}{M + {A}_{33} ( {𝓏}_{n} )} [ - W + B - {C}_{33} {𝓏}_{n} - {C}_{D}^{{}_{} *} {y}_{n} \vert {y}_{n} \vert - {\sum }_{i = 0}^{n} {K}_{33} ( {t}_{n} - {t}_{i} , {𝓏}_{n} ) {y}_{i} Δ t ]\end{matrix} \} .$$

During the lowering simulation, the body position keeps changing and so are the added mass of infinite frequency and radiation damping coefficients (or retardation functions). Therefore, they are calculated for several drafts and interpolated by 3rd order Lagrange interpolating function as

$$\\ \begin{matrix}{A}_{33} ( 𝓏 ) = {\sum }_{i = 0}^{3} {A}_{33} ( ∞ , {d}_{i} ) {N}_{i} ( 𝓏 ) , {K}_{33} ( t - τ , 𝓏 ) = {\sum }_{i = 0}^{3} {K}_{33} ( t - τ , {d}_{i} ) {N}_{i} ( 𝓏 ) , & Eq . 9\end{matrix}$$

$$\\ i = 0 , 1 , 2 , 3 , with$$

$$\\ \begin{matrix}{N}_{i} ( 𝓏 ) = {\prod }_{\begin{matrix}0 \leq j \leq 3 \\ i \neq j\end{matrix}} ( 𝓏 - {𝓏}_{j} ) / ( {𝓏}_{i} - {𝓏}_{j} ) with {𝓏}_{i} = {d}_{i} - {d}_{0} , & Eq . 10\end{matrix}$$

where the shape functions, Nᵢ, interpolate the added mass and retardation functions with reference to four pre-selected drafts, dᵢ; here, d₀ is the lowest draft whereas d₃ the deepest. In this regard, the transient-motion simulation can be considered as body-nonlinear simulation (19).

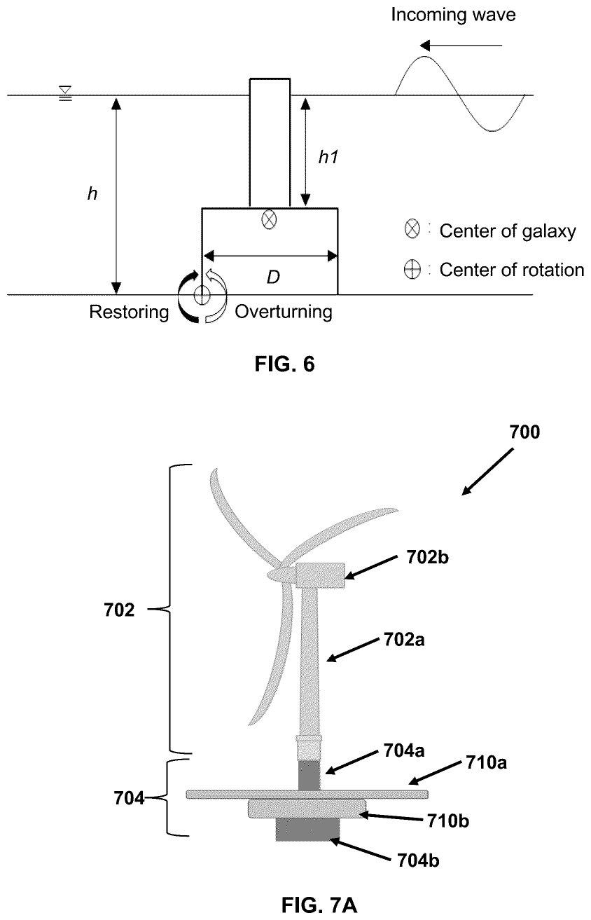

FIG. 6 is a schematic illustration of the overturning moment when the bucket foundation is landed on the seabed. The maximum overturning moment is estimated when the bucket is landed at the seabed but not penetrated into the soil yet. As mentioned earlier, sea state-4 is assumed, where the significant wave height is 2.5 m and peak period is 8.1 s. The maximum overturning moment for the most probable extreme wave height in the sea state 4 is calculated. The stability is evaluated based on restoring moment due to self-weight of the mono-bucket against the wave-induced overturning moment.

The strip-based Morison's force and overturning moment are given by

$$\\ \begin{matrix}dF = ρ \frac{π {D}^{{}_{} 2}}{4} {C}_{M} a ( t ) d 𝓏 + 0.5 ρ {DC}_{D} u ( t ) \vert u ( t ) \vert d 𝓏 and dM = ( 𝓏 + h ) dF & Eq . 11\end{matrix}$$

with time-varying water particle velocity and accelerations along the depth:

$$\\ u = \frac{π H}{T} \frac{cosh k ( 𝓏 + h )}{sinh kh} sin ( kx - ω t ) and a = - \frac{2 {π}^{{}_{} 2} H}{{T}^{{}_{} 2}} \frac{cosh k ( 𝓏 + h )}{sinh kh} cos ( kx - ω t )$$

where C_{M} and C_{D} are inertia and drag coefficients, h is the water depth, H is wave height, T is wave period, k is wavenumber, ω is wave frequency.

The inertia and drag coefficients are determined based on KC (Keulegan-Carpenter) number and oscillatory Reynolds numbers. Based on the depth-averaged KC and Reynolds numbers, the inertia and drag coefficients of C_{M}=2.0 and C_{D}=0.6 are selected for the strip of cylindrical shape (20). The most probable extreme wave height for 3 hours is approximately twice of the given significant wave height (=2.5m), i.e., H_{E}≈5 m . Applying the peak wave frequency with the most probable extreme wave height, the corresponding time-varying wave-induced overturing moment is found as follows:

$$\\ \begin{matrix}{M}_{over} = {M}_{I} cos ω t + {M}_{D} sin ω t \vert sin ω t \vert = ( \frac{2 {π}^{{}_{} 2} H}{{T}^{{}_{} 2} sinh kh} ) [ {C}_{I , mono}^{{}_{} *} {\int }_{- {h}_{1}}^{0} f ( 𝓏 ) d 𝓏 + {C}_{I , bucket}^{{}_{} *} {\int }_{- h}^{- {h}_{1}} f ( 𝓏 ) d 𝓏 ] cos ω t + \frac{1}{2} {( \frac{π H}{T sinh kh} )}^{2} [ {C}_{D , mono}^{{}_{} *} {\int }_{- {h}_{1}}^{0} g ( 𝓏 ) d 𝓏 + {C}_{D , bucket}^{{}_{} *} {\int }_{- h}^{- {h}_{1}} g ( 𝓏 ) d 𝓏 ] sin ω t \vert sin ω t \vert & Eq . 12\end{matrix}$$

where f(z)=(z+h)cosh k(z+h) and g(z)=(z+h)(1+cos 2k(z+h)); h and h₁ are as described below.

Then, the maximum overturning moment may be calculated by

$$\\ \begin{matrix}\frac{{dM}_{over}}{dt} = - ω {M}_{I} sin ω t + 2 ω {M}_{D} cos ω t \vert sin ω t \vert = 0. & Eq . 13\end{matrix}$$

Since M₁ is much greater than 2M_{D} in the present bucket cases, when sin ωt=0, the overturning moment has a maximum, i.e., M_{over,max}=M₁. On the other hand, the restoring moment by the wet weight can be calculated by:

$$\\ \begin{matrix}{M}_{res} = 0.5 DW , & Eq . 14\end{matrix}$$

where D is bucket's diameter, and W is the structural wet weight.

The stability of the system can be checked by the ratio of the maximum overturning moment over the restoring moment, i.e., μ=M_{over,max}/Mᵣₑₛ. If μ<1, the system is stable against the overturning moment. Alternatively, the wave-induced inertia force can be more accurately calculated by the 3D diffraction panel program WAMIT. Then the above formulas can be compared with the diffraction calculation. The overturning moment can be calculated by WAMIT as

$$\\ \begin{matrix}\begin{matrix}{M}_{over , max} = 0.5 {H}_{E} \vert - i ω ρ {\int }_{{S}_{wet}} {φ}_{D} j \cdot ( ( r - {r}_{C . R .} ) \times NdS ) \vert \\ = 0.5 {H}_{E} \vert - i ω ρ {\int }_{{S}_{wet}} {φ}_{D} {N}_{5} dS - i ω ρ h {\int }_{{S}_{wet}} {φ}_{D} {N}_{1} dS + 0.5 i ω ρ D {\int }_{{S}_{wet}} {φ}_{D} {N}_{3} dS \vert \\ = 0.5 {H}_{E} \vert {X}_{5} + {hX}_{1} - 0.5 {DX}_{3} \vert ,\end{matrix} & Eq . 15\end{matrix}$$

where H_{E}(=5m) is the most probable extreme wave height, ωₚ(=2π/Tₚ) is the peak angular frequency, φ_{D} is the diffraction velocity potential in complex value, j=(0,1,0) is a unit vector along the axis of overturning moment, r=(x, y, z) is a coordinate vector from origin of the global cartesian coordinate system, r_{C.R.}=(−0.5D,0,−h) is the center of rotation from the origin in FIG. 6; h is the water depth, and D is the bucket's diameter. N=(N₁, N₂, N₃) is the normal vector over the wetted surface, and r×N=(N₄, N₅, N₃) is generalized normal vector for rotational motion. Also, X₁ and X₃ are exciting forces in surge and heave, and X₅ is pitch exciting moment given in Eq. 4. All the exciting forces and moment are normalized by incident wave amplitude.

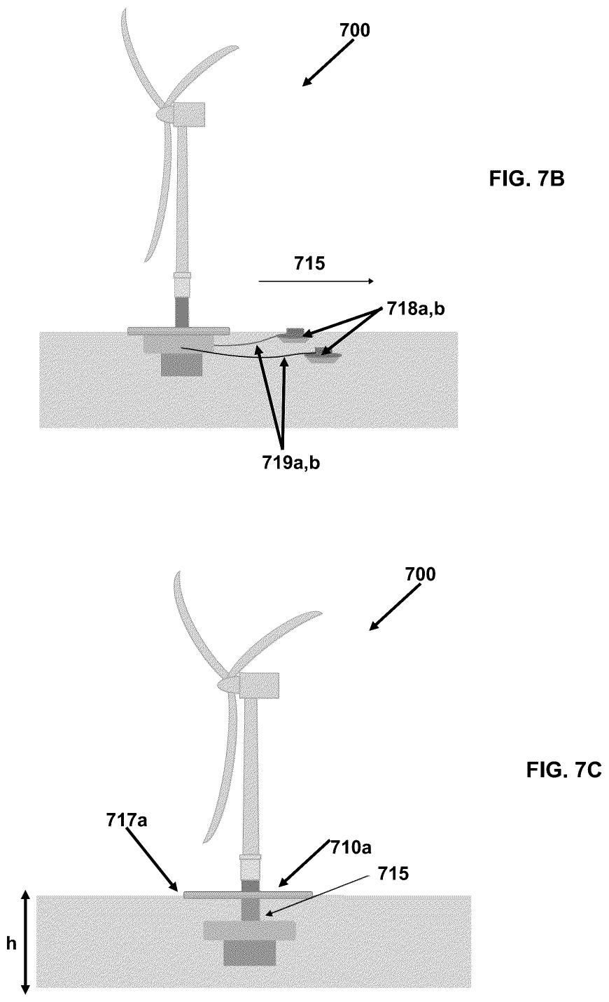

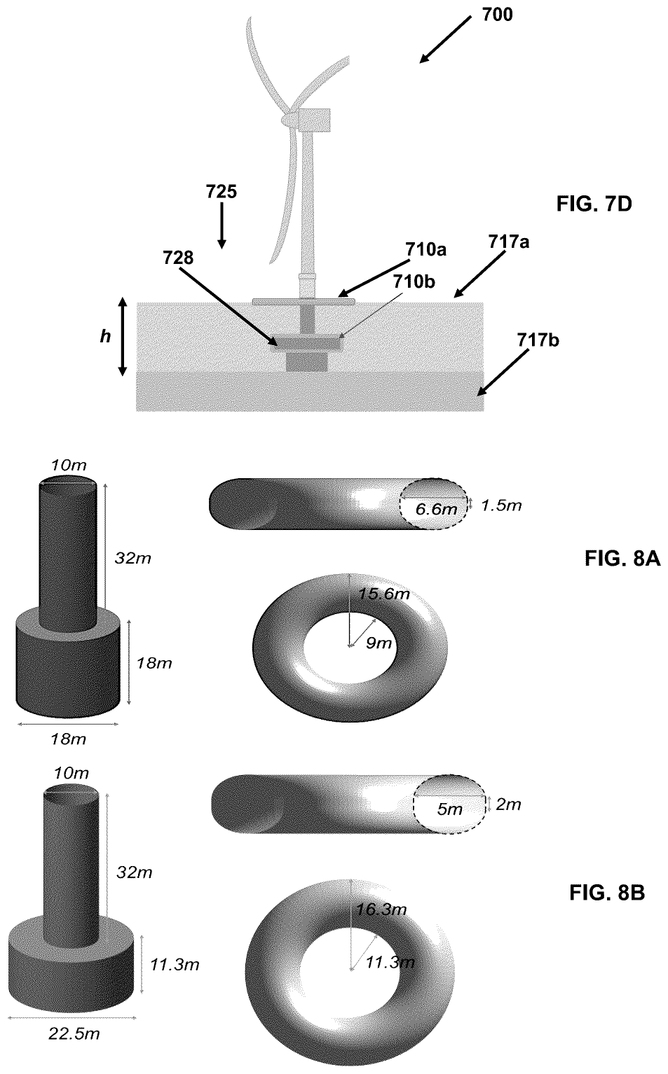

FIGS. 7A-7D are side views illustrating the wet towing of a wind turbine mounted on a mono-bucket. The wind turbine may have a standard design with a generating capacity of 5 megawatts, 10 megawatts or 15 megawatts (MW). Table 2 shows the dimensional scaling for each for wet towing to a target water depth of 30 m and L/D=0.5.

TABLE 2
Scaling for 5 MW, 10 MW and 15 MW

| | | NREL | IEA | |
|---|---|---|---|---|
| | Capacity | 5 MW | 10 MW | 15 MW |
| RNA | Mass (kton) | 0.3 | 0.63 | 1.0 |
| rotor | COG (m) | 87.5 | 119 | 150 |
| Tower | Mass (kton) | 0.25 | 0.6 | 0.9 |
| | COG (m) | 34.1 | 46.4 | 58.5 |

Target water depth = 30 m maintained

| | | | | |
|---|---|---|---|---|
| Monopile | Diameter (m) | 6.5 | 9 | 10 |
| (32 m) | Thickness | 0.62 | 0.85 | 0.95 |
| | COG (m) | | | |
| Bucket | Diameter (m) | 13.1 | 17.9 | 22.5 |
| | Sidewall length (m) | 6.1 | 8.0 | 11.3 |
| | (L/D = 0.5) | | | |
| | Thickness (D/t = 209) | 0.063 | 0.086 | 0.108 |
| | COG (m) | −32.1 | −32.7 | −33.8 |

FIG. 7A is a side view of a whole unit 700 to be wet-towed. The unit is a wind turbine 702 with a tower 702a and rotor assembly 702b mounted on a mono-bucket 704 having a monopile 704a to which the tower is secured and a bucket or bucket foundation 704b. A pair of buoys 710a,b, i.e., an upper buoy 710a and a lower buoy 710b, are disposed around the mono-bucket.

With continued reference to FIG. 7A, FIG. 7B is a side view illustrating wet-towing 715 of the whole unit 700 out to the installation site 720 (see FIG. 7C) via tugboats 718a,b and cables 719a,b.

With continued reference to FIGS. 7A-7B, FIG. 7C is a side view illustrating releasing at 715 the upper buoy 710a at the installation site with a target water depth h. After release, the upper buoy is free to slide and remains on the sea surface 717a and provides stability, but not buoyancy. Buoyancy loss due to the release of the upper buoy is compensated for by the additional buoyancy of the tower 702a.

With continued reference to FIG. 7C, FIG. 7D is a side view of the landing 725 of the whole unit 700 on the seabed 717b. The landing is accomplished by ballasting 728 the lower buoy 710b. This enables the unit to slowly sink a depth h to the seabed while the upper buoy 710a maintains stability on the sea surface 717a during the sinking.

The following examples are given for the purpose of illustrating various embodiments of the invention and are not meant to limit the present invention in any fashion.

### Example 1

### Principal Dimensions of Slender and Wide Bucket Foundations

Feasibility studies were performed for slender and wide mono-bucket dimensions (see Examples 2 and 3). The ratio of bucket's sidewall length to diameter, L/D, is 1.0 and 0.5, respectively. These are two extreme cases of bucket design for the NREL 15 MW turbine based on a series of rigorous soil-structure interaction analysis (21, 22). The principal dimensions of the mono-buckets and corresponding wrap buoys are given in Table 3, and the corresponding figures are illustrated in FIGS. 8A-8B.

TABLE 3
Principal dimension of mono-buckets

| | | |
|---|---|---|
| Monopile | Height (m) | 32 |
| | Diameter (m) | 10 |
| | Thickness* (m) | 0.95 |
| | Density (kg/m\hat{ }3) | 7900 |
| | Mass (Kiloton) | 0.75 |
| | Center of Mass (m) | −14 |

| | | | |
|---|---|---|---|
| Bucket | L/D | 1 | 0.5 |
| | Length, L (m) | 18 | 11.3 |
| | Diameter, D (m) | 18 | 22.5 |
| | Thickness(m) | 0.10 | 0.11 |
| | Mass (Kiloton) | 1.01 | 1.03 |
| | Center of Mass (m) | −37.2 | −33.8 |
| Wrap | Inner radius (m) | 9 | 11.3 |
| buoys | Outer radius (m) | 15.6 (9 + | 16.3 (11.3 + |
| | | 2 × 3.3) | 2 × 2.5) |
| | (Section) radius | 3.3 | 2.5 |
| | (Section) vertical | 1.5 | 2 |
| | height | | |

*Equivalent thickness

### Example 2

### Slender Bucket L/D=1.0

### Intact Stability

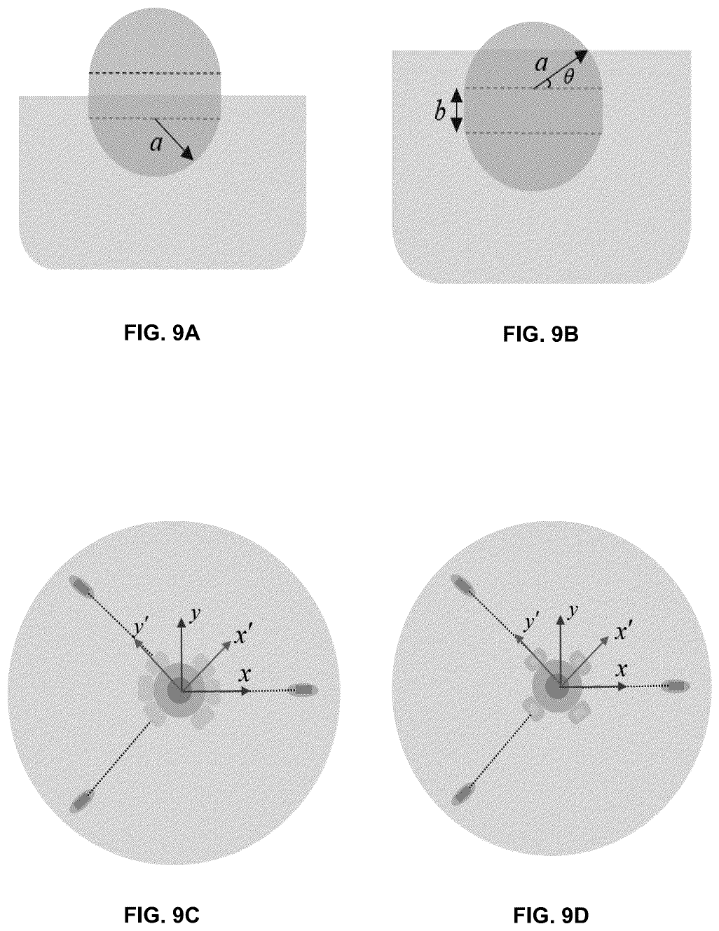

Based on the formula given in Eq. 1, the metacentric heights are calculated for all stages of the lowering operation as given in Table 4. In the formula of Eq. 1, z_{G} is determined by z_{G}=KG−d , where d is the instantaneous draft (see FIG. 5), and KG is a fixed value and z_{B}(=KB−d) and BM(=I_{xx(yy)}/∇) vary according to the change of draft and wetted geometry. KB and values for partially submerged wrap buoys for stages 2-4 are illustrated in FIGS. 9A-9B and calculated:,

$$\\ \begin{matrix}\frac{π {a}^{{}_{} 2} ( a - \frac{4 a}{3 π} ) + 2 ah ( 2 a + h )}{π {a}^{{}_{} 2} + 4 ah} , and & Eq . 16\end{matrix}$$

$$\\ \begin{matrix}\frac{3 ( {a}^{{}_{} 3} + {a}^{{}_{} 2} b ) ( 2 θ + sin 2 θ ) + {a}^{{}_{} 3} ( 3 π - 4 {cos}^{{}_{} 3} θ ) + ( 12 {a}^{{}_{} 2} b + 6 {ab}^{{}_{} 2} )}{3 {a}^{{}_{} 2} ( 2 θ + π + sin 2 θ ) + 12 ab} . & Eq . 17\end{matrix}$$

The second moment of waterplane areas stages 3-4 are illustrated in FIGS. 9C-9D and calculated for I^{xx}, I^{yy}, I^{x′x′}, and I^{y′y′}:

$$\\ \begin{matrix}{I}_{xx} = \frac{( 3 π + 2 \sqrt{2} ) [ {( R + a + a cos θ )}^{4} - {( R + a - a cos θ )}^{4} ]}{16} , & Eq . 18\end{matrix}$$

$$\\ \begin{matrix}{I}_{yy} = \frac{( 3 π - 2 \sqrt{2} ) [ {( R + a + a cos θ )}^{4} - {( R + a - a cos θ )}^{4} ]}{16} , and & Eq . 19\end{matrix}$$

$$\\ \begin{matrix}{I}_{{x}^{{}_{} ′} {x}^{{}_{} ′}} = {I}_{{y}^{{}_{} ′} {y}^{{}_{} ′}} = \frac{3 π [ {( R + a + a cos θ )}^{4} - {( R + a - a cos θ )}^{4} ]}{16} and & Eq . 20\end{matrix}$$

$$\\ \begin{matrix}{I}_{xx} = {I}_{yy} = {I}_{{x}^{{}_{} ′} {x}^{{}_{} ′}} = {I}_{{y}^{{}_{} ′} {y}^{{}_{} ′}} = \frac{π [ {( R + a + a cos θ )}^{4} - {( R + a - a cos θ )}^{4} ]}{8} . & Eq . 21\end{matrix}$$

During the wet tow, the center of the wrap buoy is located at 11 m from the bucket keel. As shown below, the present dimension (L/D=1.0) has positive GMs at all stages, which indicates that the system is stable during the whole stage of towing and installation. As three tugboats maintain their positions and provide additional tensions via towing lines, it also gives additional stability of the body during the entire lowering operation. As the transverse (roll) and longitudinal (pitch) GMs might be different due to non-axisymmetric arrangement of wrap buoys during the sequential lowering processes as illustrated in FIGS. 2A-21, the smallest GM values are given in Table 4.

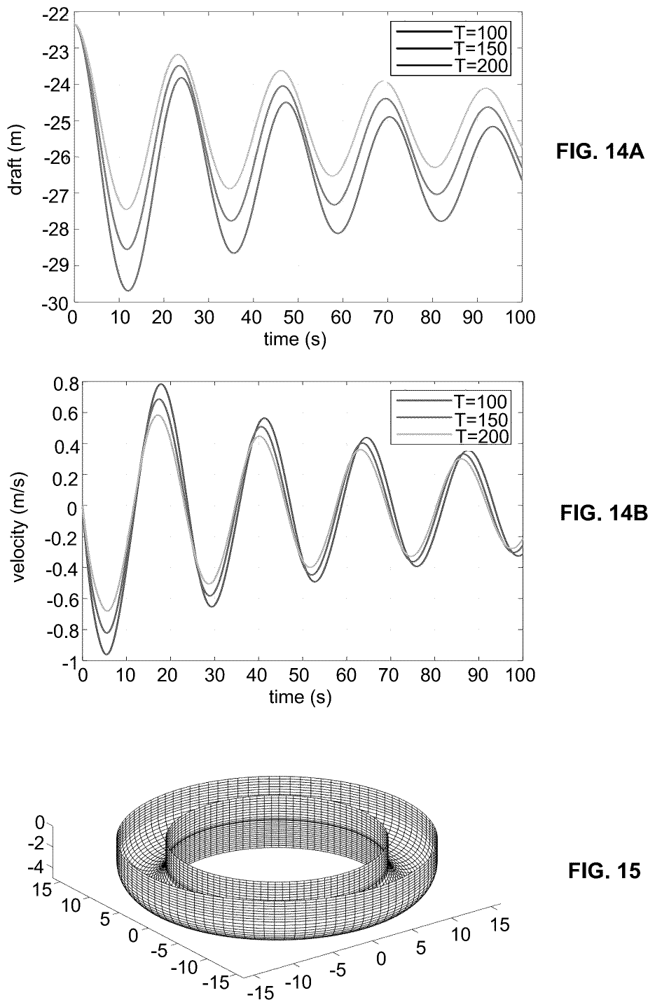

The GMs and drafts tabulated here are the values that exclude the towline tensions and the buoyancy from the bucket's wall and lid thickness as their contributions are slight in the intact stability. But they are all considered in the dynamic lowering simulation for double checking. In Table 4, we can observe that there is a significant increase of draft from stage 4 to 5. This is because the remaining two wrap buoys are fully submerged at the equilibrium position of stage 5 (see FIG. 2G), so additional buoyancy after that is only from the increase of tower submergence. For this reason, the transient response becomes considerable and thus the transient dynamic simulation of the stage 4 to 5 is illustrated in FIG. 14 as the worst case scenario.

TABLE 4
Intact stability in the lowering operation (L/D = 1.0)

| Stages | d (m) | BM (m) | z_{B} (m) | z_{G} (m) | GM (m) |
|---|---|---|---|---|---|
| 1 (Towing) | 11 | 24.09 | −1.76 | 9.75 | 12.58 |
| 2 (Lower shackles | 18.7 | 24.38 | −1.67 | 2.08 | 20.63 |
| released) | | | | | |
| 3 (6 buoys) | 19.57 | 12.93 | −2.07 | 1.17 | 9.69 |
| | | | | | (lowest) |
| 4 (4 buoys) | 21.23 | 10.36 | −3.10 | −0.48 | 7.74 |
| | | | | | (lowest) |
| 5 (2 buoys) | 29.01 | 0.29 | −7.86 | −8.26 | 0.68 |

| | | |
|---|---|---|
| 6 (Seabed) | 30 | No stability required |

### Wave-Induced Motion Statistics

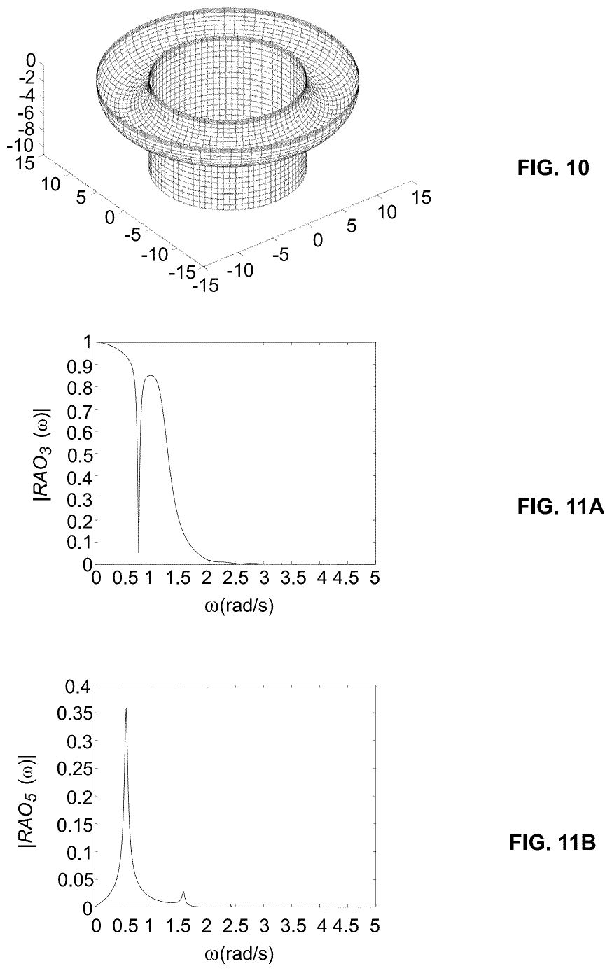

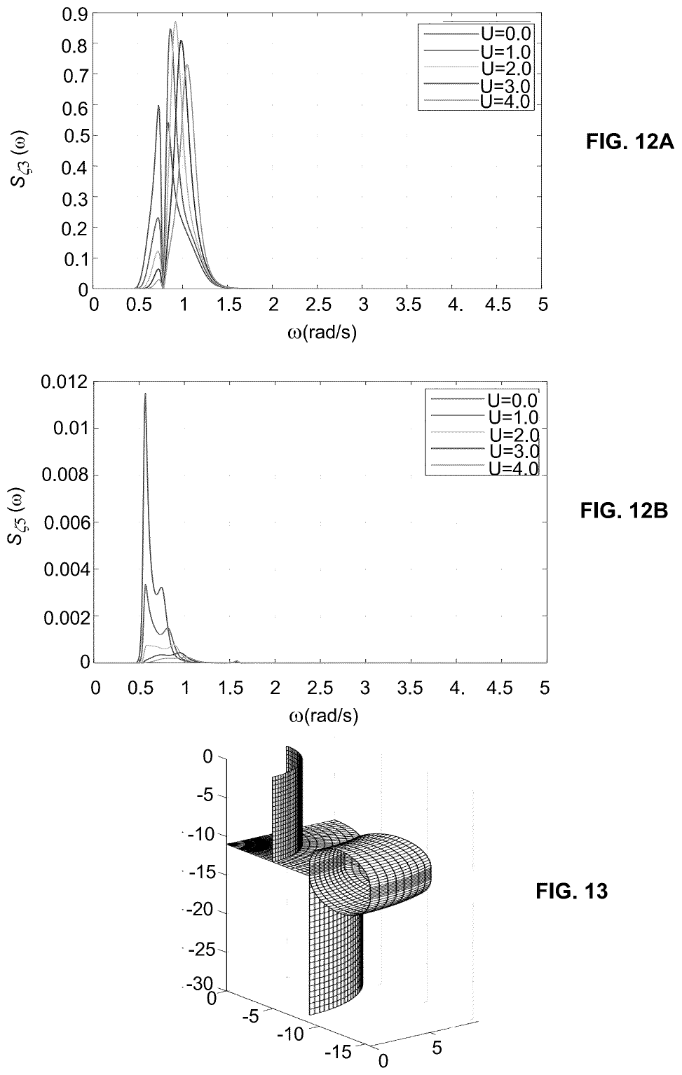

The wave-induced motion statistics are evaluated by using the generated energy spectrum and the RAOs calculated by program WAMIT. The generated hydrodynamic mesh at the wet-tow position is visualized in FIG. 10 and the WAMIT inputs for the RAO calculations are detailed in Table 5. The heave and pitch motion RAOs are shown in FIG. 11A-11B. Also, the corresponding motion spectra are also given in FIG. 12A-12B. The detailed wave and motion statistics are summarized in Table 6. The standard deviations, significant wave(motion) amplitudes, and the most probable extreme wave(motion) amplitudes are given for the applied sea states 4, which can be considered as the roughest sea condition for wet-tow and installation. As can be seen in the heave RAO, the motion at a certain frequency is noticeably low. This tendency is also observed in the case of wrap buoy only forming torus without the bucket foundation.

As mentioned, 3% and 5% of critical damping are imposed as a linear equivalent viscous damping for heave and pitch to avoid unrealistically large resonance peaks. Furthermore, due to the presence of inner free surface inside the bucket sidewall, it may cause inner free-surface resonance similar to sloshing. The most probable extreme motion amplitudes are 1.7 m for heave at U=2 m/s and 8.1 degrees For pitch at U=0 m/s. As shown in Table 5, a dipole panel method is used for the numerical modeling of sidewall panel since it is very thin, for which the ordinary panel method can be problematic. This dipole-distribution option is more robust for those thin walls and also reduces computational time. More details regarding the dipole panel method can be found in (23 Liang et al., 2021; 24 Pan, 2022) and references therein.

TABLE 5
Inputs used for the 3D diffraction/radiation program WAMIT

| Diameter (m) | 18 | (bucket) |
|---|---|---|
| | 31.2 | (bucket + tube) |
| Wall thickness (m) | 0 | (dipole panel) |
| Mass (Kiloton) | 1.76 | |
| Center of mass (m) | 9.75 | |
| Radii of gyration (m) | 17.59 (rₓₓ = r_{yy}); 7.24 (r_{zz}) | |
| Draft (m) | 11 | (bucket) |
| | 4.1 | (tube) |
| Water depth (m) | 20 | |
| Wave heading (degree) | 180 | (head sea) |

TABLE 6
Wave and motion statistics: (L/D = 1.0)

| U_{TOW} | Wave amplitudes (m) | | | Heave amplitudes (m) | | | Pitch amplitudes (degree) | | |
|---|---|---|---|---|---|---|---|---|---|
| (m/s) | σ_{ζ} | ζ_{S} | ζ_{E} | σ_{ξ}_{₃} | ξ_{3, S} | ξ_{3, E} | σ_{ξ}_{₅} | ξ_{5, S} | ξ_{5, E} |
| 0.0 | 0.6256 | 1.2512 | 2.4125 | 0.4245 | 0.8491 | 1.6236 | 2.1577 | 4.3153 | 8.0943 |
| 1.0 | 0.6252 | 1.2505 | 2.4292 | 0.4356 | 0.8711 | 1.6727 | 1.4535 | 2.9070 | 5.4876 |
| 2.0 | 0.6247 | 1.2494 | 2.4424 | 0.4457 | 0.8914 | 1.7172 | 1.0119 | 2.0237 | 3.8496 |
| 3.0 | 0.6241 | 1.2482 | 2.4529 | 0.4392 | 0.8784 | 1.6973 | 0.7497 | 1.4995 | 2.8735 |
| 4.0 | 0.6233 | 1.2467 | 2.4613 | 0.4222 | 0.8444 | 1.6365 | 0.5896 | 1.1792 | 2.2742 |

### Lowering Operation

The transient response of the bucket foundation is simulated from the lowering stage 4 to 5. As stated earlier, the added mass and the retardation functions are obtained for various drafts and then interpolated by interpolating polynomial. Specifications for the lowering operation is given in Table 7 and the mesh for the hydrodynamic calculation at the selected stage is illustrated in FIG. 13. The dipole panels are used for the sidewall and top-lid part. The time-series of the transient motion and velocity are shown in FIGS. 14A-14B. The additional buoyancy due to the thickness of the bucket is additionally included for the simulation. Towline tensions are additionally given as in Eq. 6. For the present lowering simulation, the maximum overshoot draft is about 29.7 m and the maximum falling velocity is about 0.96 m/s assuming 100 tf of towline tension. Thereafter, the transient motions and velocities are significantly reduced by damping. The relevant oscillation period is about 25 seconds and the oscillation velocity is small, so the last remaining two segmented wrap buoys can further be disconnected so that the foundation can finally be mounted on the seabed with the help of line tensions.

TABLE 7
Specification for the lowering operation (L/D = 1.0)

| Height (m) | 18 (bucket sidewall); 32 (monopile) |
|---|---|
| Diameter (m) | 18 (bucket); 10 (monopile) |
| Wall thickness (m) | 0 (dipole panel) |
| Mass (kiloton) | 1.76 |
| Drag coefficients | C_{D, n} = 2.5; C_{D, t} = 0.008 |
| Tension (tf) | 100-200 |
| Draft (m) | 20-30 |
| Water depth (m) | 30 |

### Example 3

### Wide Bucket L/D=0.5

### Intact Stability

Compared to the previous slender bucket, a wider (diameter=22.5 m) and less tall (11.3 m) bucket is considered here, which can also provide enough foundation strength for the NREL 15 MW wind turbine. (21 Aubeny, 2022; 22 Aubeny and Aldawwas, 2022). From hydrodynamics point of view, the wider bucket provides larger second moment of waterplane area in pitch/roll and larger added mass and viscous drag force in transient falling, and thus it seems hydrodynamically more advantageous. By this reason, the size of the wrap buoys can be smaller compared to the previous case. It also allows initial loadout in a relatively shallow port. In Table 8, the metacentric heights are calculated for all lowering stages. One more last sub-step is added for the present case of L/D=0.5 so that the bucket can gently land on the seabed. Since the initial draft is smaller, the vertical travel distance needed to be lowered down becomes longer than the former case. In this regard, the last step was split into two sub-steps, so that we can further reduce the transient response. On the other hand, one can see that there is a temporarily negative GM in the stage 5. This issue can easily be resolved by adjusting the attachment height of wrap buoys up by 2.5 m which leads to the GM increase about 1 m. The additional restoring moment from the three towlines further increases the GM value.

TABLE 8
Intact stability in the lowering operation (L/D = 0.5)

| Stage | d (m) | BM (m) | z_{B} (m) | z_{G} (m) | GM (m) |
|---|---|---|---|---|---|
| 1 (Towing) | 10 | 24.5344 | −2.0431 | 10.9058 | 11.5855 |
| 2 (Lower | 13.0313 | 24.8169 | −1.8094 | 2.8745 | 20.1329 |
| shackel | | | | | |
| released) | | | | | |
| 3 (6 buoys) | 14.0318 | 12.5634 | −2.3852 | 1.8740 | 8.3042 |
| | | | | | (lowest) |
| 4 (4 buoys) | 15.5804 | 5.1771 | −3.6904 | 0.3254 | 1.1612 |
| | | | | | (lowest) |
| 5 (2 buoys) | 23.5925 | 0.2825 | −8.8105 | −7.6867 | −0.8418 |
| 6 (1 buoy or | 27.6822 | 0.2825 | −10.4350 | −11.7763 | 1.6238 |
| 2 half buoys) | | | | | |

| | | |
|---|---|---|
| 7 (Seabed) | 30 | No stability required |

### Wave-Induced Motion Statistics

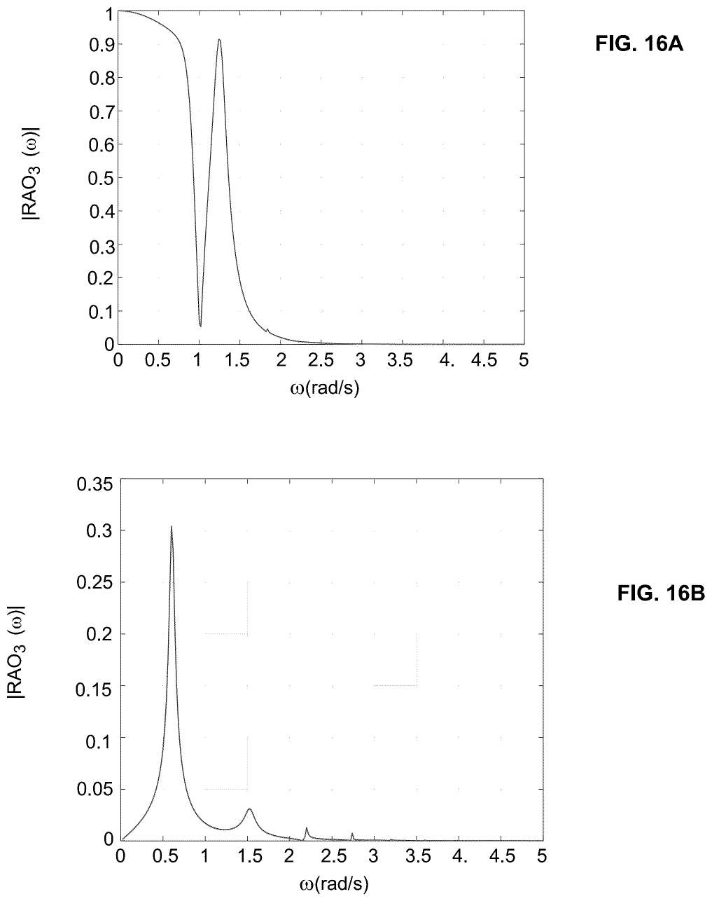

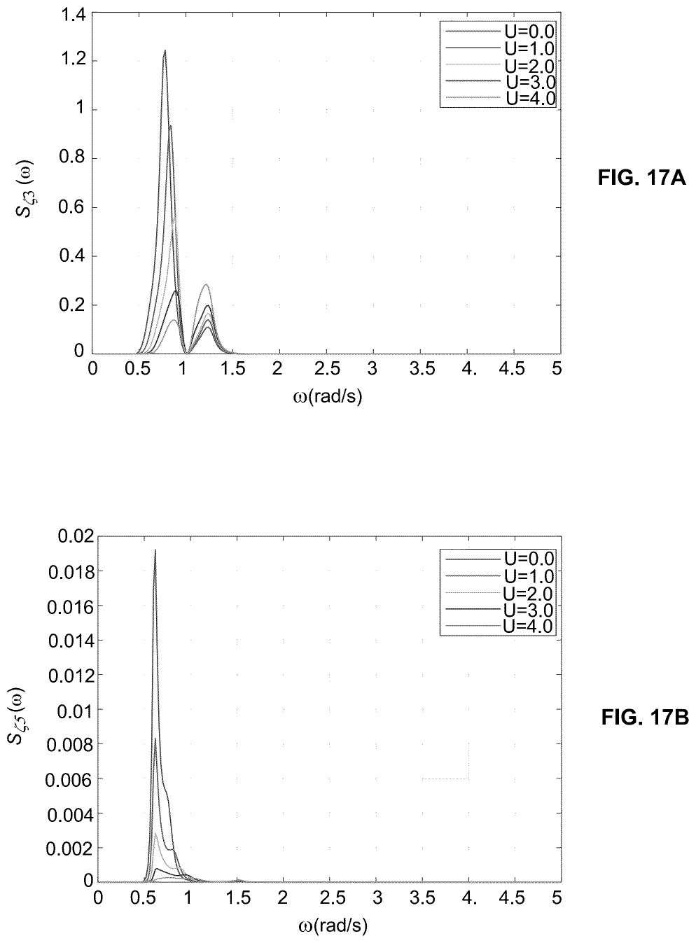

The specification for wet-towing is given in Table 9 and hydrodynamics mesh is illustrated in FIG. 15. The wrap buoys are tightly connected to the sidewall pad-eyes so that its center line coincides with the bucket tow draft of 5 m. The same sea state 4 is applied. Heave and pitch RAOs are shown in FIGS. 16A-16B and the corresponding motion spectra are presented in FIGS. 17A-17B. Typical motion statistics are tabulated in Table 10. In the present case, the highest motion amplitudes are at zero tow speed for both heave and pitch motions. The most probable extreme motion amplitude for heave is 1.8 m whereas 10.1 degrees For pitch. Both maximum heave and pitch amplitudes are slightly increased compared to the previous slender and taller bucket due to decreased viscous damping by smaller wrap buoys and shallower bucket draft.

TABLE 9
Specification for wet-towing (L/D = 0.5)

| Diameter (m) | 22.5 | (bucket) |
|---|---|---|
| | 32.5 | (bucket + tube) |
| Wall thickness (m) | 0 | (dipole panel) |
| Mass (Kiloton) | 1.78 | |
| Center of mass (m) | 10.75 | |
| Radii of gyration (m) | 17.16 (rₓₓ = r_{yy}); 8.48 (r_{zz}) | |
| Draft (m) | 5 | (bucket) |
| | 4.5 | (tube) |
| Water depth (m) | 20 | |
| Wave heading (degree) | 180 | (head sea) |

TABLE 10
Wave and motion statistics: (L/D = 0.5)

| U_{TOW} | Wave amplitudes (m) | | | Heave amplitudes (m) | | | Pitch amplitudes (degree) | | |
|---|---|---|---|---|---|---|---|---|---|
| m/s | σ_{ζ} | ζ_{S} | ζ_{E} | σ_{ξ}_{₃} | ξ_{3, S} | ξ_{3, E} | σ_{ξ}_{₅} | ξ_{5, S} | ξ_{5, E} |
| 0.0 | 0.6256 | 1.2512 | 2.4125 | 0.4797 | 0.9595 | 1.8272 | 2.6912 | 5.3823 | 10.1104 |
| 1.0 | 0.6252 | 1.2505 | 2.4292 | 0.4275 | 0.8550 | 1.6366 | 1.8713 | 3.7426 | 7.0600 |
| 2.0 | 0.6247 | 1.2494 | 2.4424 | 0.3603 | 0.7206 | 1.3863 | 1.2904 | 2.5807 | 4.8997 |
| 3.0 | 0.6241 | 1.2482 | 2.4530 | 0.3067 | 0.6134 | 1.1867 | 0.9120 | 1.8240 | 3.4930 |
| 4.0 | 0.6233 | 1.2467 | 2.4613 | 0.2971 | 0.5943 | 1.1553 | 0.6897 | 1.3793 | 2.6658 |

### Lowering Operations

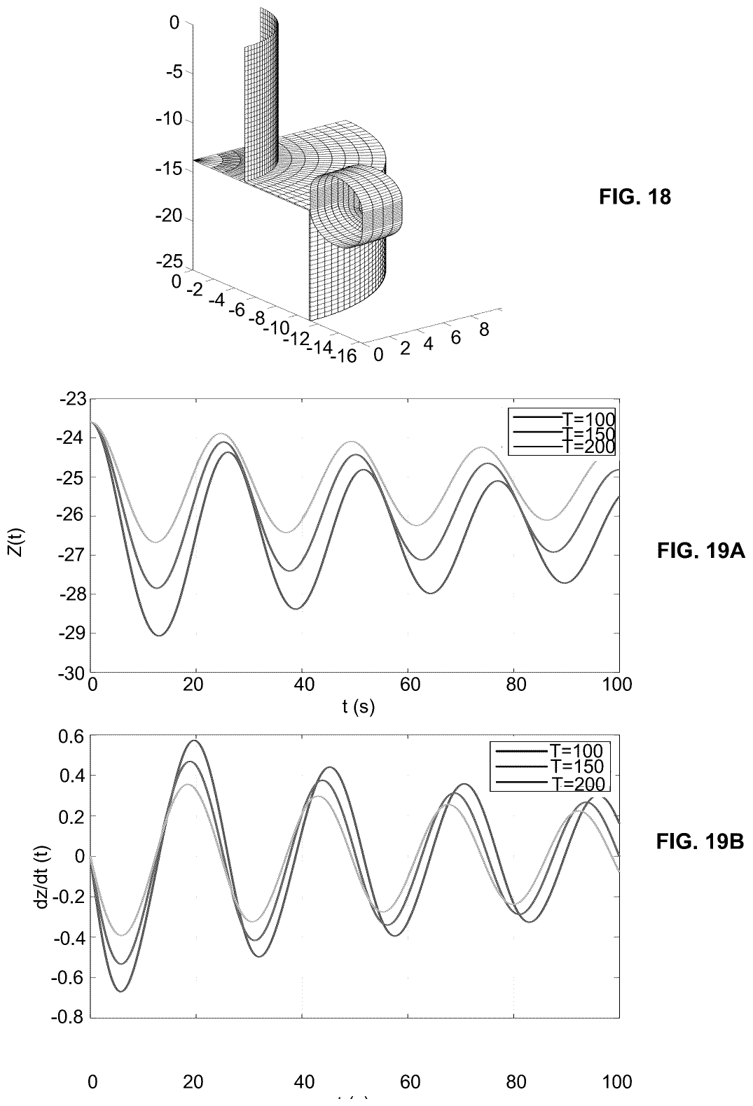

The transient response of the bucket foundation is simulated for the worst possible case i.e., between stage 5 to 6 in Table 8. As mentioned earlier, the stage 6 is a sub-step in which two half-length wrap tubes are used. The specification for the lowering operation is summarized in Table 11 and the hydrodynamics mesh used at the stage 5 is visualized in FIG. 18. The time series of the instantaneous draft and oscillatory vertical velocity during the transient motion are shown in FIGS. 19A-19B. For the present simulation, the maximum overshoot draft is about 29 m and the maximum falling velocity is about 0.67 m/s assuming 100 tf of towline tension. The vertical fall velocity is generally reduced compared to the previous slender bucket case so that the final stage near the seabed becomes safer.

TABLE 11
Specification for the lowering operation (L/D = 0.5)

| Height (m) | 11.3 (bucket sidewall); 32 (monopile) |
|---|---|
| Diameter (m) | 22.5 (bucket); 10 (monopile) |
| Wall thickness (m) | 0.1 |
| Mass (kiloton) | 1.78 |
| Drag coefficients | C_{D, n} = 2.5; C_{D, t} = 0.008 |
| Tension (tf) | 100-200 |
| Draft (m) | 23-29 |
| Water depth (m) | 30 |

### Example 4

### Hydrodynamic Performance Comparisons: L/D=1.0 vs L/D=0.5

The performance comparison between the two different bucket and wrap-buoy dimensions is made and summarized in Table 12. Firstly, regarding the intact stability during sequential installation, the wider bucket temporarily experienced small negative GM, which can be remedied by slightly raising the initial wrap-buoy connection point or through cable tensions from 3 tug-boats. However, in the wet-towing stage, the wider bucket has better stability and smaller resistance with lower draft, which is also important for the load out in a shallow port. On the other hand, the motion amplitudes of the wider bucket under the same sea state 4 are slightly larger compared to the slender and taller bucket. The increased bucket draft tends to reduce the pitch motion but may increase tow resistance. For the lowering operation, the wider bucket reduces transient motion and velocity amplitudes, which leads to higher overall safety. In general, more segments of wrap buoys can make the overall installation process milder and safer. However, it requires more acoustic shackles and connection cables and thus higher manufacturing cost. Also, water ballasting of the last remaining wrap buoys at the last stage is also possible for more gradual sinking near the seabed. As soon as the bucket is properly seated on the seabed, the suction pump can pump out the inside water so that the external hydrostatic pressure can further push the bucket into the soil. As expected, the wider bucket has better resistance against the wave-induced overturning moment when seated on the seabed, as shown in Table 12. The Morison equation overestimates the overturning moment. This is due to the fact that the hydrodynamic pressure acting on the top-lid of the bucket (Eq. 15), not considered in the Morison equation, reduces the overturning moment. After the bucket foundation is fully penetrated into the soil, the full assembly of upper part of wind turbine can be mated by using float-over installation vessel. Additionally, the maximum shackle tension was calculated for L/D=1.0 based on the lowering simulation result and it amounts to 250 tonne. This is within the range of load capacity of available acoustic shackles, e.g. Applied Acoustic Engineering Ltd. (25). During the stepwise lowering operation, maximum transient responses and velocities of wider/shallower bucket are smaller thus safer compared to those of slender bucket. When seated on the seabed, the resistance of wider bucket against wave-induced overturning moment is better than that of slender bucket.

TABLE 12
Comparison between two different bucket dimensions: L/D = 1.0 vs 0.5

| Dimension | L/D | 1.0 | | 0.5 | |
|---|---|---|---|---|---|
| Intact stability | Minimum GM | 0.68 at step 5 | | −0.84* at step 5 | |
| | | (2 wrap buoys left) | | (2 wrap buoys left) | |
| Extreme motion | Heave (m) | 1.7 | (U = 2 m/s) | 1.8 | (U = 0 m/s) |
| amplitudes (3 hrs) | Pitch (degree) | 8.1 | (U = 0 m/s) | 10.1 | (U = 0 m/s) |
| Lowering operation | Maximum draft | 29.7 | (100 tf) | 29.1 | (100 tf) |
| | Maximum vel. | 0.96 | | 0.67 | |
| Overturning moment | μ(=M_{over, max}/Mᵣₑₛ) | 0.68 | (2D Morison) | 0.46 | (2D Morison) |
| | | 0.63 | (3D Diffract.) | 0.41 | (3D Diffract.) |

### REFERENCES

1. Gaertner, et al. (Definition of the IEA 15-Megawatt Offshore Reference Wind Turbine, National Renewable Energy Laboratory: Golden, Colorado, USA, 2020.
2. Wu, J. and Kim, M.H. Energies J. Vol. 14(8490), 2021.
3. Esteban, et al. Ocean Eng, 110:281-291, 2015.
4. Esteban, et al. J Mar Sci Eng, 7(3), 2019.
5. Abdel-Rahman, K. and Achmus, M. Proceedings of 5th International Engineering Conference, Sharm El-Sheikh, Egypt, 2006.
6. Feld, T. Suction Buckets: a new innovation foundation concept, applied to offshore wind turbines, Aalborg Universitetsforlag, Aalborg, Denmark, 2001.
7. Wang, et al. Ocean Eng, 180:40-48, 2019.
8. Jeong, et al. Wind Energy, 24(5):515-529, 2021.
9. Lian, et al. Trans. Tianjin Univ., 18:79-84, 2012.
10. Zhang, et al. Ocean Engineering, 108:769-777, 2015.
11. Jiang, Z. Renewable and Sustainable Energy Reviews, 139:110576, 2021.
12. Hasselmann, K. and Olbers, D. Ergänzung zur Deut. Hydrogr. Z., Reihe A (8):12, 1-95, 1973.
13. Mazzaretto, et al. Ocean Eng, 266:112756, 2022.
14. Lee, C.H. WAMIT Theory Manual, Department of Ocean Engineering, Massachusetts Institute of Technology, Cambridge, MA, USA, 1995.
15. Huang, et al. Numerical Simulation on Dynamics of Suction Piles During Lowering Operations, The 21st International Offshore and Polar Engineering Conference, Maui, Hawaii, USA, 2011.
16. Det Norske Veritas, DNV-RP-H103 Modelling and Analysis of Marine Operations, Det Norske Veritas, Høvik, Oslo, Norway, 2000.
17. Orcina Ltd., Payload handling: F07 Suction anchor lowering.
18. Weisstein, Eric W. Gill's Method. From MathWorld-A Wolfram.
19. Jang, H.K. and Kim, M.H., Ocean Engineering J. 176:31-45, 2019.
20. Journee, J.M. and Massie, W. Offshore hydromechanics, Delft University of Technology Delft, 2001.
21. Aubeny, C.P. Simulate Suction Installation, prepared for New York State Energy Research and Development Authority, Project 106, Vibratory-Installed Bucket Foundation for Fixed Foundation Offshore Wind Towers, Texas Engineering Experiment Station, College Station, Texas, 2022.
22. Aubeny, C.P. and Aldawwas, A. Phase 1 Comparative Evaluation of Installation Methods, prepared for New York State Energy Research and Development Authority, Project 106, Vibratory-Installed Bucket Foundation for Fixed Foundation Offshore Wind Towers, Texas Engineering Experiment Station, College Station, Texas, 2022.
23. Liang, et al. European Journal of Mechanics-B/Fluids, 86:223-230, 2021.
24. Pan, Z. Ocean Eng, 249:110938, 2022.
25. Applied Acoustic Engineering Ltd., Wireless Acoustic Load Shackle System, Technical Specification, Issue 1.
26. Fiorentino, et al. 2019 IEEE/OES Twelfth Current, Waves and Turbulence Measurement (CWTM), 2019.
27. Sundt, et al. Marine Biodiversity Records, 2, 2009.

What is claimed is:

1. A method for installing a wind turbine bucket foundation at a target location on a seabed, comprising:
attaching a set of buoyancy devices to an outer wall of the bucket foundation;
towing the bucket foundation to the target location and positioning it over the target location;
releasing one-by-one a pair of buoyancy devices symmetrically from the outer wall; and
repeating the releasing step until all the buoyancy devices are free such that the bucket foundation is positioned on the target location on the seabed.

2. The method of claim 1, further comprising:
retrieving the set of buoyancy devices for reuse.

3. The method of claim 1, wherein the attaching step comprises:
securing the buoyancy devices to the outer wall of the bucket foundation via upper cables, lower cables, upper acoustic shackles and lower acoustic shackles.

4. The method of claim 1, wherein the releasing step comprises:
unsecuring the lower acoustic shackles via remote control to elevate a buoyancy center of the bucket foundation;
unsecuring symmetrically a pair of the buoyancy devices via a remote acoustic signal to alter a weight-buoyancy equilibrium to lower the bucket foundation; and
repeating the step of symmetrically unsecuring a pair of the buoyancy devices one-by-one until the bucket foundation rests on the seabed at the target location.

5. The method of claim 1, wherein the set of buoyancy devices comprises a segmented wrap-buoy.

6. A wet-towing process for installing a wind turbine in a body of water, comprising:
securing a segmented wrap buoy comprising an even number of buoy units to a bucket foundation attached to the wind turbine;
wet-towing the bucket foundation to an installation site on the body of water;
releasing pairs of buoy units comprising the segmented wrap buoy one-by-one via an acoustic signal to sequentially lower the bucket foundation onto the installation site in the body of water; and
retrieving the segmented wrap buoy for reuse.

7. The wet-towing process of claim 6, wherein the securing step comprises attaching the segmented buoy to the bucket foundation via acoustic shackles and cables.

8. The wet-towing process of claim 6, wherein the releasing step comprises:
sending a signal to remotely release the acoustic shackles; and
sending an acoustic signal to sequentially release the pairs of buoy units.

9. The wet-towing process of claim 8, wherein releasing each pair of buoy units alters a weight-buoyancy equilibrium, thereby lowering the bucket foundation into the body of water until the installation site is reached.

10. The wet-towing process of claim 6, wherein the body of water is an ocean, a sea or a lake, said bucket foundation sequentially lowered to an ocean bed, a seabed or a lake bed.

11. A method for wet-towing a wind turbine for installation in a body of water, comprising:
mounting the wind turbine to a mono-bucket forming a single unit;
disposing a pair of wrap buoys around the mono-bucket;
towing the mono-bucket to an installation site on a body of water;
releasing a first wrap buoy of the pair; and
ballasting a second wrap buoy of the pair to submerge the mono-bucket to a target water depth in the body of water.

12. The method of claim 11, wherein the first wrap buoy is an upper buoy and the second wrap buoy is a lower buoy.

13. The method of claim 12, wherein the upper wrap buoy after release is free-floating and provides stability without buoyancy to the unit during the ballasting step.

14. The method of claim 11, wherein the body of water is an ocean, a sea or a lake, said target water depth down to an ocean bed, a seabed or a lake bed.

15. A method for installing a wind turbine in a body of water, comprising:
towing at least a bucket foundation component for a wind turbine to a target site on the body of water, said bucket foundation encircled with at least two wrap buoys; and
submerging the bucket foundation via release of at least one wrap buoy to land on the target site in the body of water.

16. The method of claim 15, wherein said bucket foundation is encircled with a segmented wrap buoy with an even number of segments, each segment of said wrap buoy secured to the bucket foundation via an upper acoustic shackle and a lower acoustic shackle, said submerging step comprising:
unsecuring the lower acoustic shackles on each segment of the wrap buoy via remote control to elevate a buoyancy center of the bucket foundation;
unsecuring symmetrically a pair of the segments via a remote acoustic signal to alter a weight-buoyancy equilibrium to lower the bucket foundation; and
repeating the step of symmetrically unsecuring a pair of the segments one-by-one until the bucket foundation rests on the target site.

17. The method of claim 16, further comprising retrieving the segmented wrap buoy for reuse.

18. The method of claim 16, wherein the bucket foundation comprises the wind turbine secured thereto to form a single unit for towing.

19. The method of claim 18, wherein the bucket foundation comprises an upper wrap buoy and a lower wrap buoy each circumferentially attached thereto, said submerging step comprising:
releasing the upper wrap buoy thereby providing stability without buoyancy to the single unit; and
ballasting the lower wrap buoy to submerge the bucket foundation to rest on the target site.

20. The method of claim 15, wherein the target site is on an ocean bed, a seabed or a lakebed.
